(19) United States
(12) Patent Application Publication
(10) Pub. No.: US 2008/0217883 A1
(43) Pub. Date: Sep. 11, 2008

(54) Tractor Adapted to Be Connected to a Semi-Trailer

(75) Inventors: Jens Gustafsson, Goteborg (SE); Tobias Vikstrom, Lerum (SE); Mikael Lennartsson, Kode (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 12/089,189

(22) PCT Filed: Nov. 6, 2006
(86) PCT No.: PCT/SE2006/001261

§ 371 Date: Apr. 3, 2008

(30) Foreign Application Priority Data
Nov. 7, 2005 (SE) 0502459-1

(51) Int. Cl. B62D 53/06

(52) U.S. Cl. 280/425.1

(57) ABSTRACT

A tractor adapted to be connected to a semi-trailer is provided and includes a chassis having at the rear end portion a fifth wheel and behind that a pick up ramp arranged to guide the trailer in position so that a king pin on the trailer can enter an opening in the fifth wheel when the tractor is driven in reverse towards the trailer. The pick up ramp is moveable by power means between an upper tilted pick up position and a lower storage and driving position in which the ramp rests on beams of the chassis.

The present invention relates to a tractor adapted to be connected to a semi-trailer and comprising a chassis, at least one front wheel axle at the front portion and at least one rear wheel axle at the rear portion of the chassis, a cab at the front portion and a fifth wheel at the rear portion, the fifth wheel having means to connect the truck to the king pin of a semi-trailer.

Previously known tractors of the type described above usually have a chassis comprising two longitudinal frame beams which have rear end portions sloping backwards. The height of the rear edge of these frame beams are adapted to the lower edge of the front end of that type of semi-trailers which the tractor is design for so that a portion of this sloping end portion, when the tractor is driven in reverse towards the semi-trailer, can be moved in under the trailer before the front edge of the trailer contacts the beams. When the tractor continues to move in reverse the front edge of the trailer will slide on the sloping surface of the end portion at the same time as the trailer will be raised until finally the king pin on the trailer enters an opening in the fifth wheel on the tractor.

When the tractor is driven with a semi-trailer connected to it a certain vertical angle movement of the trailer relative to the tractor has to be allowed to compensate for uneven road surfaces, sloping ferry ramps etc. The maximum angle allowed is determined on the length of the overhang of the tractor chassis, the angel of the sloping end portion of the chassis and the height of the fifth wheel above the ground.

Generally, semi-trailers are designed to carry as much payload as possible. However, there are certain criteria which set the limits in this respect. The maximum height of the trailer is limited by the height of tunnels and underpasses.

The required minimum vertical angle movement of the trailer relative to the tractor sets the limit for the minimum ground clearance which in turn is determined by the height of the fifth wheel and the sloping pick up ramp constituted by the sloping rear end portion of the tractor chassis beams.

One purpose of the present invention is to obtain a tractor described by way of introduction which can have a lower chassis and a lower fifth wheel than previously known tractors and still allow enough vertical angle movement of the trailer relative to the tractor.

This is obtained according to the present invention by means of a tractor having pick up means mounted at or near the rear end of the chassis, said pick up means being moveable between an upper and a lower position and arranged, when the tractor is moving in reverse and the rear end of the chassis is moving in under the semi-trailer, to catch means on the semi-trailer and, caused by continued movement of the tractor in reverse, to lift the front end of the semi-trailer and to guide the king pin of the semi-trailer to a predetermined position in relation to the fifth wheel.

During driving with the pick up means in its lower position out of the way there are no obstructions behind the fifth wheel other than the overhang which, since it does not have to serve as a pick up arrangement, can be made lower than what has been previously possible.

In a preferred embodiment of the present invention the pick up means is a ramp pivotally journalled on the chassis. Power operated means connect the ramp with the chassis and are arranged, when operated, to tilt the ramp between an upper pick up position, in which a front end of the ramp levels with the fifth wheel and a rear end of the ramp is situated at a lower level adapted to the lower level of the semi-trailer to be connected, and a storage and driving position, in which the complete ramp is lying at a level below the fifth wheel.

This embodiment is particularly advantageous because the pick up ramp can serve as a protection shield over the rear overhang of the chassis and thereby enable the use of this space as a compartment for fragile equipment such as batteries, pneumatic tanks and the like.

The invention will be described in more detail below with reference the accompanying drawings, wherein

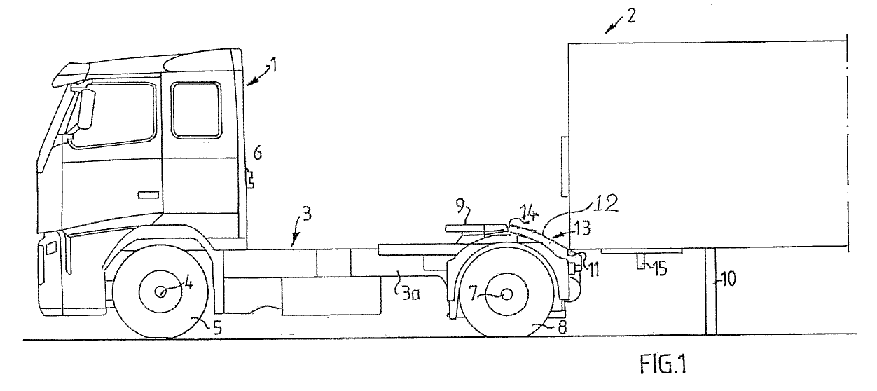

FIG. 1 shows a side view of a preferred embodiment of a tractor according to the present invention connected to a semi-trailer,

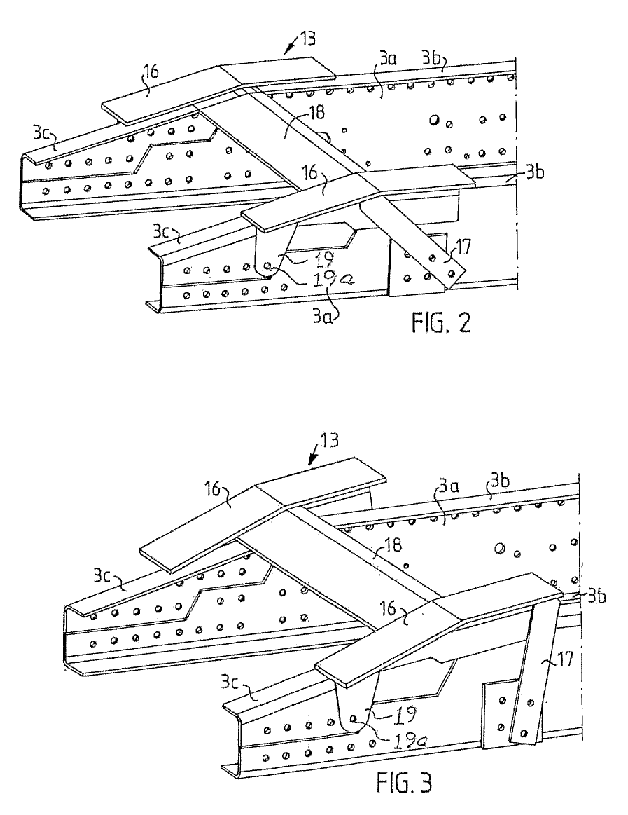

FIG. 2 shows a perspective view of the rear portion of a pair of chassis beams and a and a pick up frame according to a preferred embodiment of the invention with the pick up frame in a lower storage position,

FIG. 3 shows a view corresponding to FIG. 2 with the pick up frame in an upper pick up position

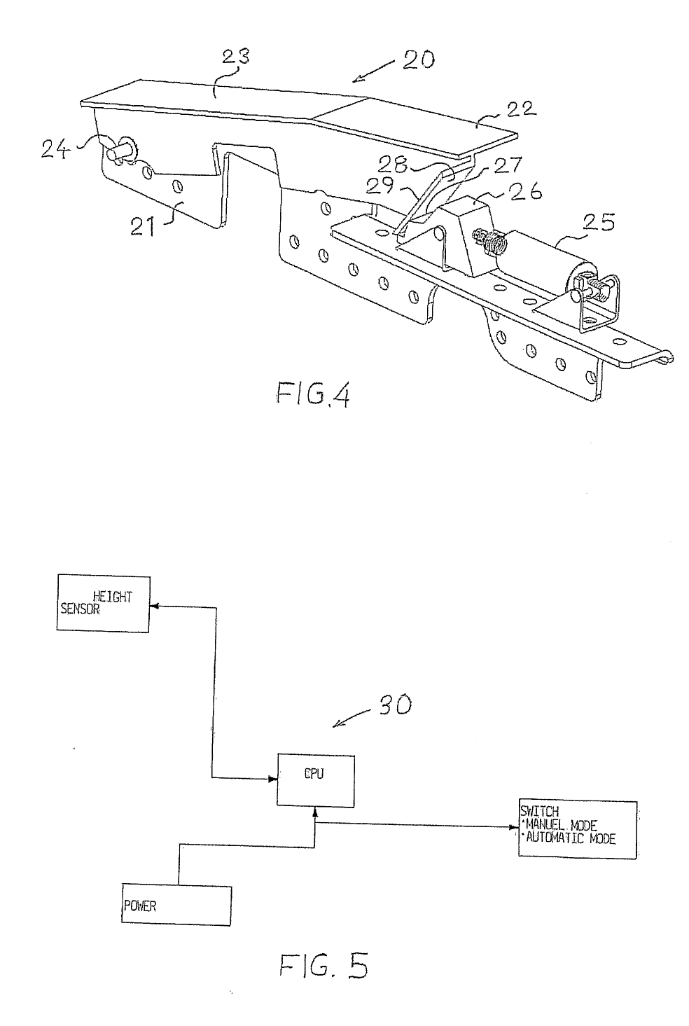

FIG. 4 shows a perspective view of a pick up frame module and

FIG. 5 shows a block diagram of an equipment for adjusting the pivot angle of the pick up frame.

In FIG. 1 a tractor is generally designated 1 and a semi-trailer is generally designated 2. The tractor 1 has a chassis 3 which comprises two chassis beams 3a. The chassis 2 carries at a front portion a front wheel axle 4 with front wheels 5 and a cab 6 and at a rear portion a rear wheel axle 7 with rear wheels 8. Also in the rear portion a fifth wheel 9 is mounted.

Only a front portion of the semi-trailer 2 is shown which front portion is resting on support legs 10 prior to pick up by the tractor. In FIG. 1 the tractor has been driven in reverse to a position in which a lower front edge 11 of the semi-trailer just touches an upper surface 12 of a sloping pick up ramp, generally designated 13, on the tractor. As can be seen in FIG. 1 the pick up ramp 13 is adjusted to an upper pick up position wherein the upper edge 14 of the pick up ramp 13 levels with the upper surface of the fifth wheel 9. Starting from the position shown in FIG. 1, continued movement of the tractor 1 in reverse will result in sliding movement of the lower front edge 11 of the of the semi-trailer 2 on the sloping surface 12 of the pick up ramp 13 until a king pin 15 mounted on the underside of the semi-trailer 2 eventually is guided into and locked in an opening in the fifth wheel 9.

After the king pin 15 has been locked in the opening of the fifth wheel 9 and before driving away the pick up frame 13 is lowered to its storage and driving position (FIG. 2). When the tractor 1 has been brought to a stop and the trailer 2 is to be disconnected from the tractor 1 the above described sequence is reversed, i.e. the pick up ramp is again raised to its pick up position, the king pin 15 is disconnected from the fifth wheel 9 and the tractor is driven in the forward direction which will result in backwards sliding movement of the front edge 11 of the trailer 2 on the sloping surface of the pick up ramp 13. In this manner the tractor chassis 3 and the rear wheel suspension of the chassis will be successively unloaded from the weight of the trailer. This operation is particularly advantageous if the tractor has an air suspension because it prevents the air cushions of the suspension from suddenly raising the chassis when unloaded.

In FIG. 2 and FIG. 3 an enlargement of the pick up ramp 13 on the tractor 1 in FIG. 1 is shown in its storage and driving position and in its pick up position, respectively. The ramp 13 comprises two beams 16 which are interconnected by a cross beam 18. The beams 16 are at their rear ends connected to brackets 19 with bores 19a for pivotal mounting on the chassis beams 3a and are shaped to conform with the upper horizontal surface 3b and the inclined surface 3c of the chassis beams 3. A pair of power operated rods 17 are at one end pivotally mounted on the chassis beams 3a and contact at the other end the underside of the ramp beams 16.

The rods 17 are operated by power means (not shown), e.g. hydraulic or pneumatic piston-cylinder devices. By means of the rods 16 the ramp 13 can be tilted between a low storage and driving position (FIG. 2) resting on the chassis beams 3a and a raised pick up position (FIG. 3) in which the ends of the beams 16 are lying at the level of the upper surface of fifth wheel 9.

FIG. 4 shows an embodiment of a pick up frame module 20 which together with a second frame module (not shown) being a mirror image of the shown module 20 makes up a complete pick up frame. These frame modules can be bolted or welded to tractor chassis beams 3a which, because of the configuration of the frame modules 20, need not require a horizontal flange corresponding with the chassis beam flanges 3b, 3c.

Each frame module 20 comprises a support beam 21 and a slide beam 22 with a slide surface 23 pivotally journalled on the support beam 21 by means of a pivot pin 24. Pivotal movement is achieved by an electrically operated screw and nut device 25 connected to a sliding block 26 having an edge surface 27 contacting an inclined surface 28 of a flange 29 on the beam 22. When the screw and nut device 25 is operated it will horizontally displace the sliding block 26 thereby varying the angle of inclination of the slide beam 22 relative to the support beam 21.

In order to adapt the above described pick up frame arrangement to various tractors having fifths wheels with upper surfaces, the height over the ground of which differs between them, the pick up frame 13, 20 can be controlled by an operating equipment 30 (FIG. 5) which senses the height of the upper surface of the fifth wheel 9 and adjusts the upper position of the pick up frame 13 so that its upper edge 14 levels with the upper surface of the fifth wheel. As a sensor an ultra-sonic or infra red sensor can be used which is preferably located on the rear wall of the tractor and senses the height of the upper surface of the fifth wheel 9. The adjustment can be either manually or automatically controlled, as indicated in the diagram in FIG. 5.

1. A tractor a adapted to be connected to a semi-trailer and comprising
a chassis,
at least one front wheel axle at a front portion of the chassis and at least one rear wheel axle at the rear portion of the chassis,
a cab at the front portion of the chassis and
a fifth wheel at the rear portion of the chassis, the fifth wheel having means to connect the truck to a king pin of a semi-trailer,
pick up means mounted on the chassis proximate the rear end of the chassis, the pick up means being moveable between an upper and a lower position and arranged, when the tractor is moving in reverse and the rear end of the chassis is moving in under the semi-trailer, to catch means on the semi-trailer and, caused by continued movement of the tractor in reverse, to lift a front end of the semi-trailer and to guide the king pin of the of the semi-trailer to a predetermined position in relation to the fifth wheel, the pick up means comprising a pick up ramp which is controlled by an operating equipment equipped with sensor means sensing a height of an upper surface of the fifth wheel, the tractor further comprising means to adjust the upper position of the pick up means so that an upper edge thereof levels with the upper surface of the fifth wheel.

2. A tractor according to claim 1, wherein the pick up means is a ramp pivotally journalled on the chassis and power operated means connect the ramp with the chassis, the power operated means being arranged, when operated, to tilt the ramp between an upper pick up position, in which a front end of the ramp levels with the fifth wheel and a rear end of the ramp is situated at a lower level adapted to a level of the semi-trailer to be connected, and a storage and driving position, in which the complete ramp is lying at a level below the fifth wheel.

3. A tractor according to claim 2, wherein the pick up ramp comprises two longitudinal beams, each beam being pivotally connected proximate one end to a beam of the chassis and proximate another end to power operated means.

4. A tractor according to claim 3, wherein the longitudinal beams are interconnected by at least one transverse cross-beam.

5. A tractor according to claim 1, wherein the pick up ramp comprises two pick up frame modules being mirror images of one another, each module comprising a support beam adapted to be rigidly attached to a tractor chassis beam, a slide beam pivotally journalled on the support beam and power operated means for varying the inclination of the slide beam relative to the support beam.
